(19) United States
(12) Patent Application Publication
(10) Pub. No.: US 2026/0115822 A1
(43) Pub. Date: Apr. 30, 2026

(54) MANUFACTURING SUPPORT SYSTEM, MANUFACTURING SUPPORT PROGRAM, CONTROL METHOD, AND TERMINAL DEVICE

(71) Applicant: MISUMI CORPORATION, Tokyo (JP)

(72) Inventors: Kazuto NAKAO, Tokyo (JP); Yasuhiro MATSUMOTO, Tokyo (JP)

(73) Assignee: MISUMI CORPORATION, Tokyo (JP)

(21) Appl. No.: 19/469,682

(22) PCT Filed: Feb. 29, 2024
(86) PCT No.: PCT/JP2024/007505

§ 371 Date: Sep. 26, 2025

(30) Foreign Application Priority Data
Mar. 28, 2023 (JP) 2023-050920

(51) Int. Cl. B23K 9/095; G05B 19/4093

(52) U.S. Cl. CPC B23K 9/0953; G05B 19/40931; G05B 2219/45135

(57) ABSTRACT

The manufacturing support system transmits component data to a supplier. The component data is used for manufacturing an article including a plurality of components to be joined by welding and represents a geometric shape of each of the components. The manufacturing support system comprises a data generation unit that generates the component data so as to include, as a part of the geometric shape, a specifying object specifying a welding area in the article, and a transmission unit that transmits the generated component data to the supplier.

### CROSS-REFERENCE TO RELATED PATENT APPLICATIONS

This application is a U.S. National Phase Application under 35 U.S.C. § 371 of International Patent Application No. PCT/JP2024/007505 filed on Feb. 29, 2024, which claims the benefit of priority to Japanese Patent Application No. 2023-050920 filed on Mar. 28, 2023, all of the contents of which are incorporated herein by reference in their entireties. The International Patent Application was published in Japanese on Oct. 3, 2024 as International Publication No. WO 2024/202895 under PCT Article 21 (2).

### FIELD OF THE INVENTION

The present invention relates to a manufacturing support system that transmits component data to a supplier, a manufacturing support program and a control method for the manufacturing support system, and a terminal device that generates drawing data based on the component data.

### BACKGROUND OF THE INVENTION

JP2002-203007A discloses a method of preparing an estimate for sheet metal working. In the preparation method, three-dimensional CAD data obtained by modeling a product by three-dimensional CAD is received from an orderer. Then, the product is split into a plurality of components with reference to a three-dimensional view. In addition, a development is prepared for each of the plurality of split components. Furthermore, for calculating a welding cost, the three-dimensional view split into the plurality of components is read, a welding plane is designated, and a welding length is calculated.

JP2005-157820A discloses a sheet metal equipment product sales system. In the system, design data such as a CAD drawing is received and a three-dimensional view is prepared. Then, the three-dimensional view is split into three-dimensional views of components, and a development is prepared with reference to the three-dimensional views of the components. Furthermore, it is determined whether component machining of a product is possible, and when it is determined that machining is possible for all the components, a welding area is extracted and a machining method is examined.

JP2010-184278A discloses a robot system including a welding robot. In the system, a welding line to be welded by the welding robot is automatically selected based on a workpiece figure of three-dimensional CAD data displayed on a display screen.

### CITATION LIST

### Patent Literature

Patent Literature 1: JP2002-203007A
Patent Literature 2: JP2005-157820A
Patent Literature 3: JP2010-184278A

### Technical Problem

When a user places an order to a supplier for an article including a plurality of components to be joined by welding, the supplier that has received the order views a drawing, decides a welding area, and then performs manufacturing. Therefore, a considerable time is required from the reception of the order to the start of manufacturing the article. Therefore, it is required to promptly decide the welding area and start manufacturing the article.

### SUMMARY OF THE INVENTION

### Solution to Problem

A manufacturing support system according to one aspect is a manufacturing support system that transmits, to a supplier, component data for manufacturing an article including a plurality of components to be joined by welding, the component data representing a geometric shape of each of the components, the manufacturing support system comprising: a data generation unit that generates the component data so as to include, as a part of the geometric shape, a specifying object specifying a welding area in the article; and a transmission unit that transmits the generated component data to the supplier.

In addition, a manufacturing support program according to another aspect is a manufacturing support program for a manufacturing support system that includes a computer and transmits, to a supplier, component data for manufacturing an article including a plurality of components to be joined by welding, the component data representing a geometric shape of each of the components, the manufacturing support program causing the computer to function as: a data generation unit that generates the component data so as to include, as a part of the geometric shape, a specifying object specifying a welding area in the article; and a transmission unit that transmits the generated component data to the supplier.

In addition, a control method according to still another aspect is a control method for controlling a manufacturing support system that includes a computer and transmits, to a supplier, component data for manufacturing an article including a plurality of components to be joined by welding, the component data representing a geometric shape of each of the components, the method causing the computer to: generate the component data so as to include, as a part of the geometric shape, a specifying object specifying a welding area in the article; and transmit the generated component data to the supplier.

In addition, a terminal device according to still another aspect comprises: an acquisition unit that acquires component data for manufacturing an article including a plurality of components to be joined by welding, the component data representing a geometric shape of each of the components; and a drawing generation unit that generates drawing data of the components based on the acquired component data, wherein the component data includes, as part of the geometric shape, a specifying object specifying a welding area in the article.

### Advantageous Effects of Invention

As a result, component data including a specifying object specifying a welding area is automatically generated, and the time and effort for a supplier to decide the welding area can be saved, and manufacturing of an article can be promptly started.

### BRIEF DESCRIPTION OF THE DRAWINGS

FIG. 1 is a schematic configuration diagram of the entirety of a manufacturing support system.

FIG. 2 is a schematic block diagram of the manufacturing support system.

FIG. 3 is a schematic perspective view illustrating the entirety of an article.

FIG. 4 is a schematic perspective view illustrating the entirety of a component of the article.

FIG. 5 is a schematic plan view of a component to be manufactured.

FIG. 6 is a schematic perspective view illustrating the entirety of another article.

FIG. 7 is a schematic perspective view illustrating the entirety of a component of the other article.

FIG. 8 is a flowchart of a manufacturing support process.

### DETAILED DESCRIPTION OF THE INVENTION

Hereinafter, exemplary embodiments for carrying out the present invention will be described in detail with reference to the drawings. Note that dimensions, materials, shapes, and relative positions of components described in the following embodiments can be arbitrarily set, and can be changed according to a configuration of a device or a method to which the present invention is applied or various conditions. In addition, unless otherwise specified, the scope of the present invention is not limited to the embodiments specifically described below. Incidentally, in the following description, identification information is information for uniquely identifying an object to be identified. As an example, the identification information includes a character, a number, a symbol, and the like.

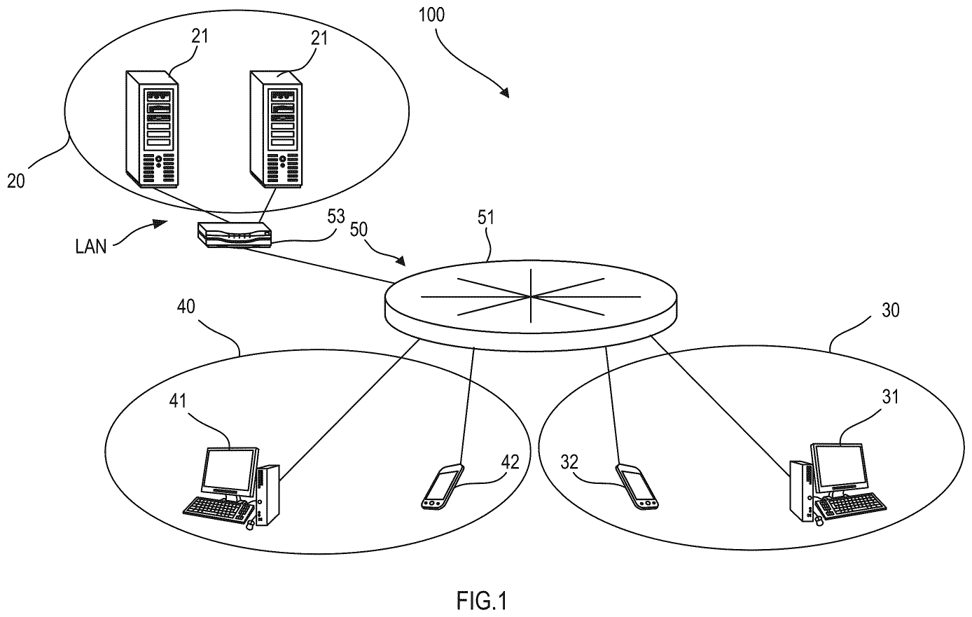

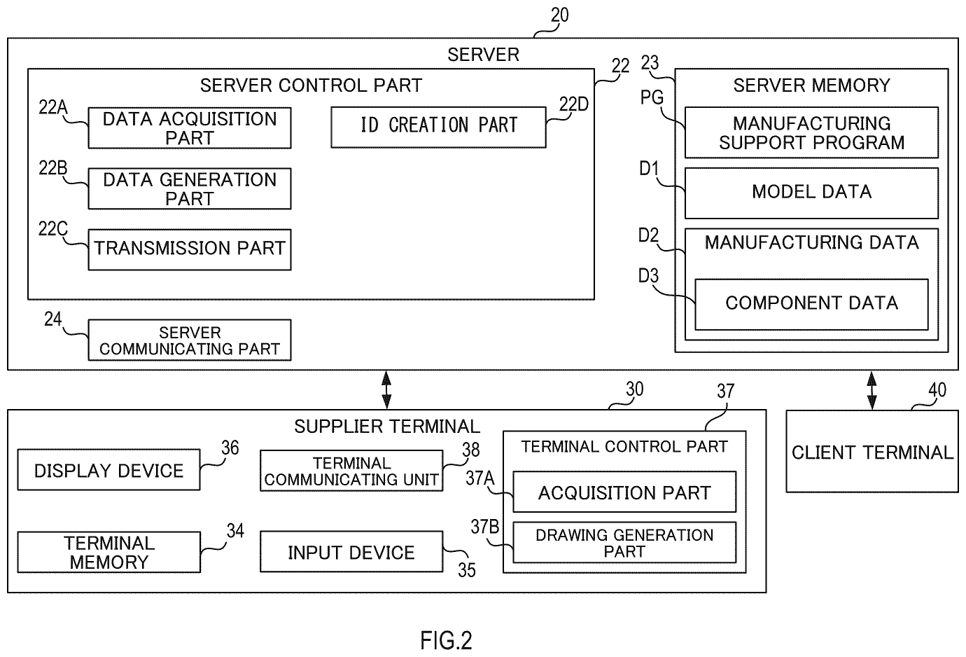

FIG. 1 illustrates a manufacturing support system 100 that transmits, to a supplier, component data D3 (FIG. 2) for manufacturing an article including a plurality of components to be joined by welding. The component data D3 represents a geometric shape of each of the components. Incidentally, the article itself may be a finished product having one integrated function, or may be one article incorporated into the finished product. Furthermore, the article includes the plurality of components including a unit, a jig, a device, and equipment.

The manufacturing support system 100 is configured as a network system including a server 20 as a manufacturing support server or a client server system. The server 20 functions as a server device, and is configured as one logical server device by combining, for example, server units 21 as a plurality of computers. However, the server 20 may be configured by the single server unit 21. Alternatively, the server 20 may be logically configured by using cloud computing.

The server 20 transmits the component data D3 to the supplier by transmitting the component data D3 to a supplier terminal 30 used by the supplier. In addition, the server 20 provides various services including an article manufacturing support service for transmitting various types of data used for manufacturing articles. The services include a distribution service for distributing a program or data to the supplier terminal 30 via a network 50 and a storage service for storing data received from the supplier terminal 30. For example, the distribution service is a service that distributes data for update.

The supplier terminal 30 is a computer device capable of network connection. For example, the supplier terminal 30 includes a stationary or book type personal computer 31, and a portable tablet terminal device 32, and the like. The supplier terminal 30 further includes a mobile terminal device such as a portable phone (including a smartphone). The supplier terminal 30 can cause the supplier to enjoy various services provided by the server 20 by implementing various types of computer software. In addition, the supplier terminal 30 can be connected to the server 20 via the predetermined network 50. A case where the supplier terminal 30 is the personal computer 31 will be described hereinafter.

In addition, the server 20 provides various services including an article estimation service to a client terminal 40 used by a user who orders the article or to the user who uses the client terminal 40. The services include a distribution service for distributing a program or data to the client terminal 40 via the network 50 and a storage service for storing data received from the client terminal 40. For example, the distribution service is a service that distributes data for update. In addition, the server 20 may execute processing such as arranging the ordered article, a delivery instruction, and billing of purchase price in response to a request from the user.

The client terminal 40 is a computer device capable of network connection. For example, the client terminal 40 includes a stationary or book type personal computer 41, and a portable tablet terminal device 42, and the like. The client terminal 40 further includes a mobile terminal device such as a portable phone (including a smartphone). The client terminal 40 can cause the user to enjoy various services provided by the server 20 by implementing various types of computer software. In addition, the client terminal 40 can be connected to the server 20 via the predetermined network 50.

The network 50 is configured such that each of the supplier terminal 30 and the client terminal 40 can be connected to the server 20. As an example, the network 50 is configured to implement network communication by using a TCP/IP protocol. Specifically, a local area network LAN connects the server 20 and the Internet 51. Then, the Internet 51 as a wide area network (WAN) and the local area network LAN are connected via a router 53. In addition, the network 50 may be any of a dedicated line, a telephone line, intranet, a mobile communication network, other communication lines, combinations thereof, and the like, and may be wired or wireless. The supplier terminal 30 and the client terminal 40 are also configured to be connected to the Internet 51. Alternatively, the server units 21 of the server 20 may be connected to each other by the Internet 51 instead of or in addition to the local area network LAN.

The user who orders the article transmits model data D1 (FIG. 2) of the article from the client terminal 40 to the server 20. Then, the server 20 receives the model data D1 from the client terminal 40 and stores the model data D1. The model data DI is three-dimensional computer aided design (CAD) data representing a shape of the article as an example, and may include information such as dimensions and positions of elements constituting the article. Specifically, the model data D1 is a shell model in which components constituting the article are integrated, a non-coupled model in which components constituting the article are separated, or an assembly model including a plurality of components. In addition, the elements are, for example, portions constituting the article or the component, such as a hole, a shaft, a step, a notch, a corner, a plane, and a ridge line, and include a shape obtained by machining.

Incidentally, the server 20 includes a supplier support server in addition to the manufacturing support server that generates the component data D3. For example, the manufacturing support server of the server 20 transmits the component data D3 to the supplier terminal 30 via the supplier support server. Alternatively, the manufacturing support server of the server 20 may function as the supplier support server. Furthermore, the manufacturing support server of the server 20 may function in cooperation with an external supplier support server. In the following example, an example in which the server 20 includes the manufacturing support server and the supplier support server will be mainly described, and processing of each of the both may be simply described as processing by the server 20.

### Control System

Next, a schematic configuration of a control system of the manufacturing support system 100 will be described with reference to FIG. 2. As illustrated in FIG. 2, the manufacturing support system 100 includes the server 20. Furthermore, the manufacturing support system 100 may include the supplier terminal 30 and the client terminal 40.

### Client Terminal

The client terminal 40 includes a control part (not illustrated) that controls the client terminal 40 and a memory (not illustrated) that stores a control program of the client terminal 40. The control part is a computer in which a processor that executes various arithmetic processes and operation control according to a predetermined program and other peripheral devices are combined. In addition, the client terminal 40 further includes a display device (not illustrated).

Furthermore, the client terminal 40 includes a communicating part (not illustrated) which is an example of a communication device that transmits and receives data to and from the server 20. In addition, the client terminal 40 includes an input device (not illustrated) including a keyboard or various switches for inputting a command and data. Incidentally, a display device such as a touch panel may function as the input device. As an example, the input device is a keyboard, a numeric keypad, a touch panel, or the like, and the user creates or changes the model data D1 by using the input device. Then, the model data D1 created using the input device is transmitted to and stored in the server 20.

### Server

The server 20 includes a server control part 22 as a control unit and a server memory 23 as a non-transitory computer-readable storage medium. The server control part 22 is configured as a computer in which a processor that executes various arithmetic processes and operation control according to a predetermined program, an internal memory necessary for the operation of the processor, and other peripheral devices are combined. The processor is, for example, a central processing unit (CPU) or a micro-processing unit (MPU), and controls the entire device based on a control program stored in the server memory 23 and also controls various processes in an integrated manner. Furthermore, the server control part 22 executes various processes associated with the setting of the welding conditions of the article based on a manufacturing support program PG stored in the server memory 23.

The server memory 23 includes random access memory (RAM) that is a system work memory for the processor to operate, and a storage device such as a read only memory (ROM), a hard disc drive (HDD), and a solid state drive (SSD) that store a program and system software. However, the server memory 23 is not limited to the example of being provided as a part of the server 20, and may be provided as a database server that cooperates with the server 20.

In addition, the server memory 23 stores the model data D1 of the article and manufacturing data D2 including the component data D3 for manufacturing the article. As an example, the component data D3 is data in a SAT file format generated based on the model data D1 which is three-dimensional CAD data. The component data D3 is data in a text file format describing a geometric shape of each element of the model data D1. Then, it is possible to create three-dimensional CAD data, three-dimensional image data, two-dimensional image data, and the like of a component from the component data D3 using any three-dimensional CAD program. Alternatively, the component data D3 may be three-dimensional CAD data, two-dimensional CAD data, or the like.

The server control part 22 is connected, in a wired or wireless manner, to an operation part (not illustrated) including a keyboard or various switches for inputting predetermined commands and data. In addition, the server control part 22 is connected, in a wired or wireless manner, to a display part (not illustrated) that displays an input state, a setting state, a measurement result, and various types of information of the server device. Incidentally, the server control part 22 can also perform control according to a program stored in a portable recording medium such as a compact disc (CD), a digital versatile disc (DVD), a compact flash (CF) card, or a universal serial bus (USB) memory, or an external storage medium such as a cloud server on the Internet.

The manufacturing support program PG stored in the server memory 23 causes the server control part 22, which is the computer to function as a data acquisition part 22A that is an example of a data acquisition unit, a data generation part 22B that is an example of a data generation unit, a transmission part 22C that is an example of a transmission unit, and an ID creation part 22D that is an example of an ID creation unit. That is, the server control part 22 includes the data acquisition part 22A, the data generation part 22B, the transmission part 22C, and the ID creation part 22D as logical devices implemented by a combination of computer hardware and software.

Incidentally, the server control part 22 includes, in addition to the logical devices described above, a logical device (not illustrated) that controls switching display of a web page and the like according to an operation of the supplier terminal 30. Furthermore, the server control part 22 includes, as another logical device, an estimation unit that prepares estimation information of the article, a provision unit that provides the user with image data generated based on the model data D1, and the like. In addition, the server memory 23 records various types of data (not illustrated) such as user information, a past estimation result, image data used to display a web page, and data including information such as a model number, a name or a feature of a product or the article.

### Data Acquisition Unit

The data acquisition part 22A acquires the model data D1 of the article. As an example, the user uploads the model data D1 to the server 20. In addition, the server control part 22 stores the model data D1 accepted from the client terminal 40 of the user in the server memory 23. Then, the data acquisition part 22A reads and acquires the model data D1 from the server memory 23. The article represented by the model data D1 includes at least two components to be welded to each other. Furthermore, the article may include a portion of the unitary piece of component as a portion that is welded after being bent.

### Data Generation Unit

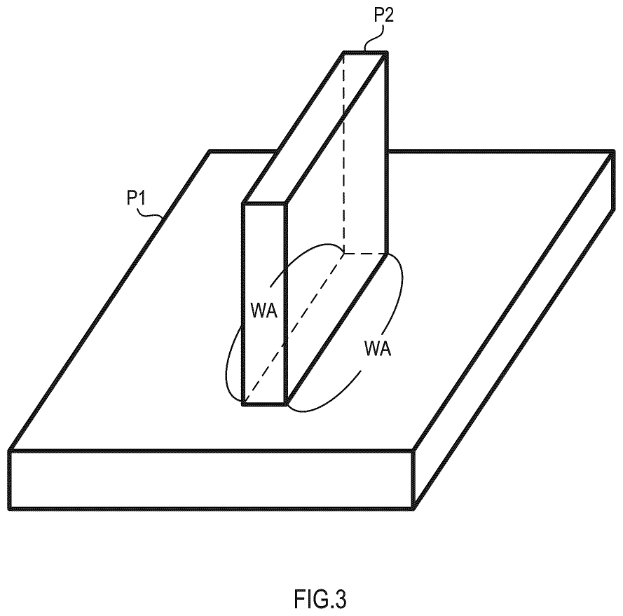

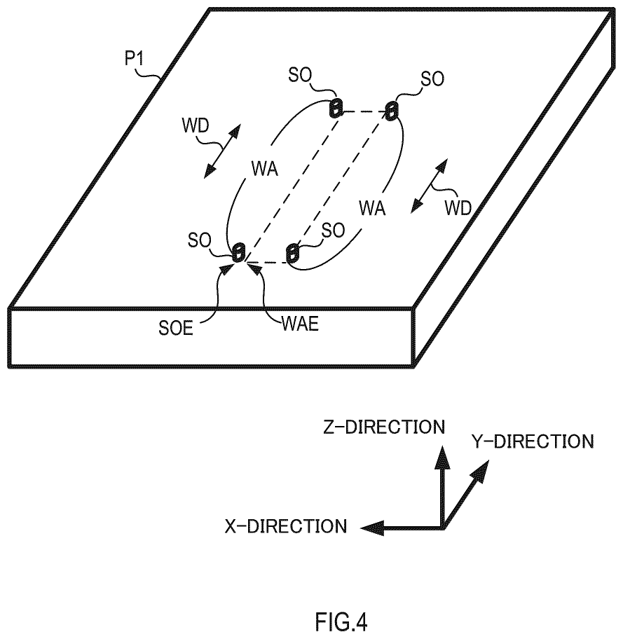

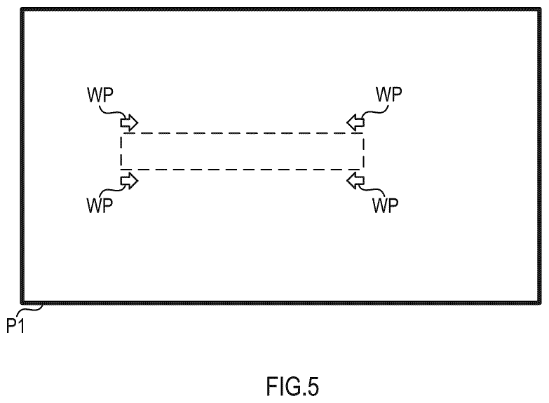

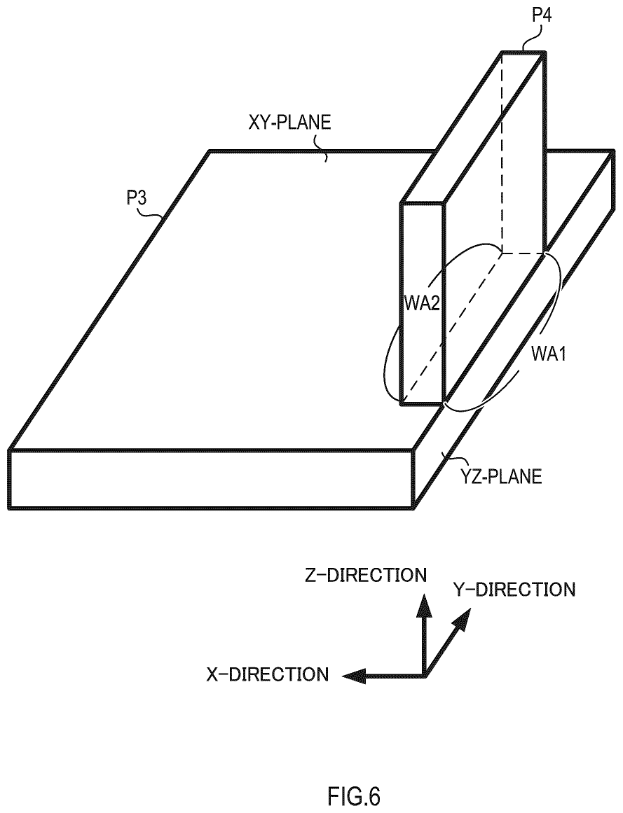

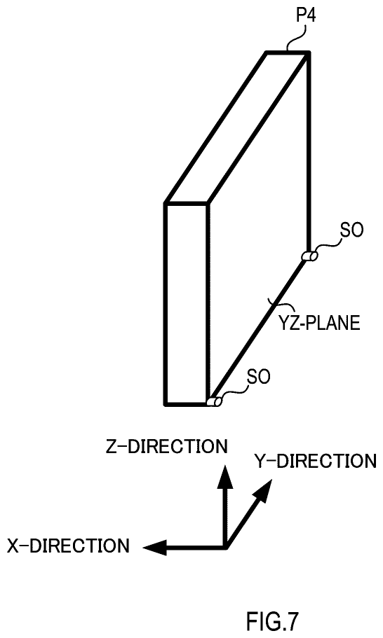

Next, the data generation part 22B will be described with reference to FIGS. 3 to 7. FIG. 3 is a schematic perspective view illustrating the entirety of an article to be manufactured. In addition, FIG. 4 is a schematic perspective view illustrating the entirety of one component of the article, and is displayed on a screen based on data. In addition, FIG. 5 is a schematic plan view of the component to be manufactured. In addition, FIG. 6 is a schematic perspective view illustrating the entirety of another article to be manufactured, and the other article is different from the article illustrated in FIG. 3. In addition, FIG. 7 is a schematic perspective view illustrating the entirety of one component of the other article, and is displayed on the screen based on data.

The data generation part 22B generates the component data D3 so as to include specifying objects SO (FIG. 4) specifying welding areas WA (FIG. 3) in the article. As an example, the article illustrated in FIG. 3 includes a plate-shaped first component P1 and a plate-shaped second component P2 welded to the first component P1. Further, the welding area WA is a boundary between the first component P1 and the second component P2, and is a region on the first component P1 along a side extending in the longitudinal direction of the second component P2. Incidentally, the welding area WA may be a continuous region (for example, a straight line, a curve, or the like), or may be a plurality of aligned points (or spots).

In addition, the data generation part 22B generates the component data D3 so as to include the specifying objects SO as a part of the geometric shape. As an example, in FIG. 4, a rectangular region overlapping the second component P2 on the first component P1 is virtually indicated by a broken line. Here, the welding areas WA correspond to two line segments along sides extending in the longitudinal direction of the region. Further, the specifying objects SO are disposed near both ends of the two line segments so as to specify the welding areas WA. Therefore, in the example of FIG. 4, four specifying objects SO are disposed on the first component P1. With the specifying object SO, the supplier can visually recognize the welding area WA and suppress an error in welding.

In addition, the specifying object SO is a virtual element that is not included in the geometric shape represented by the model data D1 of the article and is not formed in the article to be actually manufactured. Further, the specifying object SO, as a part of the geometric shape represented by the component data D3, has a set dimension. That is, as illustrated in FIG. 4, the specifying object SO has dimensions in the X direction, the Y direction, and the Z direction. As an example, the dimensions in the X direction, the Y direction, and the Z direction are 1.5 mm or more and 2.5 mm or less. In addition, when the specifying object SO protrudes from a plane of a component, a protruding amount (for example, a height in the Z direction in FIG. 4) of the specifying object SO is 0.1 mm or more and 0.5 mm or less. As a result, the supplier can visually distinguish and recognize the specifying object SO from the plane of the component. Alternatively, the specifying object SO may be an element having a two-dimensional shape with no dimension in the Z direction (that is, a direction away from the plane of the component).

In addition, the specifying object SO has a size in a three-dimensional space, and is an element protruding from the plane (for example, an appearance plane) of the component or an element recessed with respect to the plane of the component. For example, the specifying object SO illustrated in FIG. 4 is a cylinder. However, the specifying object SO may have any shape as long as it has a three-dimensional shape. As an example, the specifying object SO may be a sphere, a polygonal prism such as a triangular prism or a quadrangular prism, a protrusion, a linear or curved rim, and a three-dimensional body imitating an arrow or a teardrop shape. Furthermore, the specifying object SO may be a hole or a groove. However, since the specifying object SO protrudes from the plane of the component, it is possible to prevent the specifying object SO from being erroneously formed on the component. That is, when a dimension of the component to be welded is specified, the specifying object SO protruding from the plane of the component is clearly recognized as an element not to be formed on the component. Therefore, it is possible to prevent the specifying object SO from being erroneously formed on the component.

Then, the specifying object SO specifies the welding area WA in the article. That is, the component data D3 includes a plurality of the specifying objects SO as a part of the geometric shape so as to indicate a start point and an end point of the welding area WA in one component to which the other component is welded. Specifically, in the example illustrated in FIG. 4, the specifying objects SO specify the welding areas WA on the first component P1 to which the second article P2 is welded as the welding areas WA in the article. For example, one of the two specifying objects SO aligned in a welding direction WD indicated by an arrow in FIG. 4 indicates the start point of the welding area WA, and the other one indicates the end point of the welding area WA. Incidentally, when there are a plurality of the welding areas WA, some of the welding areas WA may not be specified by the specifying object SO. In addition, a part of one welding area WA may not be specified by the specifying object SO.

In addition, shapes and/or at least some dimensions of a plurality of specifying objects SO specifying the same welding area WA are identical. Specifically, in the example illustrated in FIG. 4, two specifying objects SO specifying one welding area WA have the same shape and the same dimensions. As a result, the supplier can visually distinguish and recognize the specifying object SO from the other elements of the component, and can suppress the error in welding. However, the plurality of specifying objects SO only need to have similar shapes or dimensions. For example, the shape or dimension of at least one specifying object SO of the plurality of specifying objects SO may be different from the shape or dimension of the other specifying object SO. Even in this case, the supplier can visually distinguish and recognize the specifying object SO from the elements of the component.

The supplier recognizing the welding area WA overlaps the second component P2 on the first component P1, and welds from the start point indicated by one specifying object SO to the end point indicated by the other specifying object SO. Therefore, as illustrated in FIG. 5, the supplier forms marks WP on the component to be actually manufactured. As an example, the supplier generates two-dimensional data used for nesting so as to convert the specifying objects SO corresponding to positions of the start point and the end point of the welding into the marks WP using a CAD system or a CAM system. A method of forming the marks WP on the component to be manufactured actually is set in advance in the CAD system or the CAM system on the supplier side. For example, the method of forming the marks WP is set such that the component is machined to have shapes of arrows as illustrated in FIG. 5 by scribing. In another example, the method of forming is set such that paint is applied to the component in the shapes of the arrows as illustrated in FIG. 5. Incidentally, the method of forming the marks WP may be decided in any manner by the supplier in the CAD system or the CAM system on the supplier side. FIG. 5 illustrates the schematic plan view of a component to be actually manufactured, and the marks WP having arrow shapes are formed at four positions corresponding to four specifying objects, respectively. Incidentally, the shape of the mark WP is not limited to the arrow, and may be a circle, a polygon, or the like. In addition, the shape of the mark WP may be decided in any manner by the supplier in the CAD system or the CAM system on the supplier side. Furthermore, the number of the marks WP formed at the position corresponding to one specifying object SO may be two or more.

In addition, the specifying object SO may have any size and any shape, and may be set such that a region for forming the mark WP can be secured. As a result, it is possible to prevent the mark WP from being unable to be formed at an area where the specifying object SO is disposed in the component data D3. Incidentally, welding between components is not limited to a mode of continuous welding. The supplier may perform intermittent welding (for example, spot welding) at a plurality of points aligned from the start point to the end point.

In addition, each of the specifying objects SO is disposed at a position not overlapping with the welding area WA. Furthermore, an end of each of the specifying objects SO is disposed at a position linearly aligned with the start point or the end point of the welding area WA. In the example of FIG. 4, an end SOE of the specifying object SO is disposed at a position linearly aligned with a start or end point WAE of the welding area WA. As a result, the supplier can visually recognize the start or end point WAE of the welding area WA, and the error in welding can be suppressed.

Incidentally, the specifying object SO may further specify a direction from the start point to the end point of the welding area WA and/or a direction from the end point to the start point of the welding area WA. As an example, the specifying object SO is a three-dimensional body having a tapered cross section, such as an ellipse, or an arrow-shaped three-dimensional body, and is disposed in a posture indicating each of the above directions. For example, when the specifying object SO is the arrow-shaped three-dimensional body, the specifying object SO is disposed near each of both the ends of the welding area WA. Then, a pair of the specifying objects SO is disposed in a posture in which tapered portions thereof face each other (that is, a posture in which the specifying objects SO are plane-symmetric with a plane crossing the welding area WA as a reference).

In addition, when one component is welded to the other component, the specifying object SO may specify the welding area WA of the other component in the component data D3 of the one component to be welded. As an example, in the other article illustrated in FIG. 6, a fourth component P4, which is one component, is welded to a third component P3, but a side of the third component P3 and a side of the fourth component P4 overlap each other at a welding area WA1. Therefore, there is no region where the specifying object SO is disposed on an XY plane extending in the X direction and the Y direction of the third component P3. In addition, a YZ plane extending in the Y direction and the Z direction of the third component P3 also has no sufficient area for forming the mark WP.

Therefore, the specifying objects SO specifying the welding area WA1 of the third component P3 are included in the component data D3 of the fourth component P4 which is another component. Then, the specifying objects SO included in the component data D3 of the fourth component P4, which is the other component, specify the welding area WAI of the third component P3. Specifically, as illustrated in FIG. 7, in the component data D3 of the fourth component P4, the specifying objects SO specifying the welding area WA1 of the third component P3 are disposed on the YZ plane. As a result, even when there is no sufficient area for disposing the specifying objects SO, the welding area WAl can be specified by the specifying objects SO.

In addition, when the welding area WA is specified, one three-dimensional shape may be configured by combining the specifying objects SO disposed in the respective components. That is, two specifying objects SO specifying the same start or end point of the same welding area WA may be disposed to form a large three-dimensional shape together. For example, in the article illustrated in FIG. 6, the specifying object SO (not illustrated) having a prismatic shape is disposed on the XY plane of the third component P3 in order to specify a welding area WA2. Furthermore, the specifying object SO (not illustrated) having the same size and the same shape is disposed on an XZ plane (not illustrated) of the fourth component P4 at a position in contact with the specifying object SO of the third component P3. As a result, the specifying object SO of the third component P3 and the specifying object SO of the fourth component P4 are combined to form a large prism. Therefore, the supplier can visually recognize a position where the components are in contact with each other, and can suppress an error in welding.

The data generation part 22B generates the component data D3 including the specifying object SO based on the model data D1 of the article. As an example, the data generation part 22B generates the component data D3 directly from the model data D1 of the article. Alternatively, the data generation part 22B may indirectly generate the component data D3 from the model data D1 of the article. In this case, the data generation part 22B generates the component data D3 from three-dimensional model data or the like of a component generated based on the model data D1 of the article.

As a specific example, the data generation part 22B identifies an area where welding can be performed in the article based on the model data D1. For example, the data generation part 22B executes a shape recognition process of the article on the model data D1. Then, the data generation part 22B recognizes a shape of each element of the article based on the model data D1 in the shape recognition process. Furthermore, the data generation part 22B recognizes a shape of each element of each component constituting the article. Subsequently, the data generation part 22B creates pattern data having a topology structure. For example, the topology structure has information on a connection relationship between components, an adjacency relationship between components, and recognition of planes surrounded by lines for each component.

Then, the data generation part 22B identifies the welding area WA in the article. As an example, the data generation part 22B recognizes a boundary line between components in contact as the welding area WA. Furthermore, the data generation part 22B decides a position where the specifying object SO of each of the components is disposed so as to specify a start point or an end point of the identified welding area WA. At this time, the data generation part 22B decides the position where the specifying object SO is disposed so as to avoid a plane having no region for disposing the specifying object SO or having no sufficient area for disposing the specifying object SO. Then, the data generation part 22B generates the component data D3 of each of the components constituting the article so as to include the specifying object SO disposed at the decided position.

In addition, the data generation part 22B generates image data of the article. For example, the data generation part 22B generates two-dimensional or three-dimensional image data of the article. Then, the data generation part 22B stores the manufacturing data D2 including the image data of the article and the component data D3 in the server memory 23. However, the data generation part 22B may independently generate the component data D3 and store the component data D3 in the server memory 23.

### Transmission Unit

The transmission part 22C transmits the component data D3, generated by the data generation part 22B, to the supplier. Specifically, the transmission part 22C causes the server communicating part 24 to transmit the manufacturing data D2 including the component data D3 to the supplier terminal 30. For example, the transmission part 22C causes to transmit the manufacturing data D2 to the supplier terminal 30 via the supplier support server of the server 20. In addition, the transmission part 22C may cause to transmit the component data D3 alone to the supplier terminal 30 via the support server.

Furthermore, the transmission part 22C may cause to transmit the manufacturing data D2 or the component data D3 directly to the supplier terminal 30. Alternatively, the transmission part 22C may store the manufacturing data D2 or the component data D3 in the supplier support server or the manufacturing support server. In this case, the supplier downloads the manufacturing data D2 or the component data D3 from the supplier support server or the manufacturing support server.

### ID Creation Unit

The ID creation part 22D creates identification information (hereinafter, also referred to as an article ID) for specifying the article and a data name of the component data D3. The article ID and the data name include a character, a number, a symbol, and the like. Then, the article ID is associated with the manufacturing data D2 of each article stored in the server memory 23 and order information indicating content of an order placed by the user. In addition, the data name is associated with the component data D3 of each component stored in the server memory 23. Furthermore, the component data D3 or the data name thereof is associated with the article ID. As an example, the data name is a file name of the component data D3 in the SAT file format. Incidentally, the article ID can be set in any manner, and may be automatically decided by the ID creation part 22D or may be set by the user or an administrator of the server 20.

### Supplier Terminal

Returning to FIG. 2, the supplier terminal 30 includes a terminal control part 37 that controls the supplier terminal 30 and a terminal memory 34 that stores a control program. The terminal control part 37 is a computer in which a processor that executes various arithmetic processes and operation control according to a predetermined program and other peripheral devices are combined. In addition, the supplier terminal 30 includes an input device 35, a display device 36, and a terminal communicating part 38.

As an example, the processor of the terminal control part 37 is a CPU or an MPU, and controls the entire supplier terminal 30 based on the control program stored in the terminal memory 34 and also controls various processes in an integrated manner. In addition, the terminal memory 34 further includes a RAM that is a system work memory for the processor to operate, and storage devices such as a ROM, an HDD, and an SSD that store a program and system software. Incidentally, the terminal control part 37 can also perform control according to a program stored in a portable recording medium such as a CD, a DVD, a CF card, and a USB memory, or an external storage medium such as a cloud server on the Internet.

The terminal memory 34 is an external storage device including a non-volatile storage medium (non-transitory computer-readable storage medium) such as a hard disk and a semiconductor storage device. Furthermore, in addition to the control program, the terminal memory 34 stores various programs such as viewer software for causing the display device 36 to display the image data of the article included in the manufacturing data D2, and a web browser. In addition, the program stored in the terminal memory 34 causes the terminal control part 37, which is a computer, to function as an acquisition part 37A, which is an example of an acquisition unit, and a drawing generation part 37B which is an example of a drawing generation unit. That is, the terminal control part 37 includes the acquisition part 37A and the drawing generation part 37B as logical devices implemented by a combination of computer hardware and software. Incidentally, the terminal control part 37 includes, in addition to the logical devices described above, a logical device (not illustrated) or the like that causes display device 36 to display a web page.

### Acquisition Unit

The acquisition part 37A acquires the component data D3 for manufacturing the article including the plurality of components to be joined by welding, the component data D3 representing the geometric shape of each of the components. As an example, the acquisition part 37A acquires the component data D3 included in the manufacturing data D2 transmitted from the server 20. Alternatively, the acquisition part 37A may acquire only the component data D3 transmitted from the server 20. In addition, the acquisition part 37A may automatically acquire the manufacturing data D2 or the component data D3 from the server 20 periodically or at any timing. Furthermore, the acquisition part 37A may acquire the manufacturing data D2 or the component data D3 from the server 20 according to an operation by the supplier.

### Drawing Generation Unit

The drawing generation part 37B generates drawing data of the component based on the component data D3 acquired by the acquisition part 37A. In addition, the drawing generation part 37B stores the generated drawing data in the terminal memory 34. As an example, the drawing data is three-dimensional image data or three-dimensional CAD data, and may include the mark WP corresponding to the specifying object SO. For example, the component data D3 acquired by the acquisition part 37A is input to the drawing generation part 37B. Then, the drawing generation part 37B outputs the drawing data. In addition, the drawing generation part 37B may further generate three-dimensional image data and/or three-dimensional CAD data for displaying the entire article on the display device 36.

The input device 35 is a keyboard, a numeric keypad, a touch panel, or the like. In addition, the display device 36 displays an image based on the drawing data generated by the drawing generation part 37B or the like. Furthermore, the display device 36 displays a web page such as a setting screen and a confirmation screen for confirming the content of the order from the user. In addition, the terminal communicating part 38 is an example of a communication device that transmits and receives data to and from the server 20. For example, the terminal communicating part 38 receives the manufacturing data D2 including the component data D3 from the server 20. In addition, the terminal communicating part 38 transmits data related to manufacturing or supply of the article (for example, data indicating the dispatch date of the article) to the server 20. Alternatively, the terminal communicating part 38 may directly transmit and receive data to and from the client terminal 40.

### Manufacturing Support Process

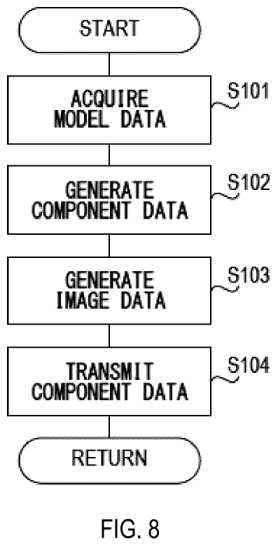

Next, a manufacturing support process by the manufacturing support system 100 will be described with reference to FIG. 8. First, the user uploads the model data DI to the server 20. Then, the server control part 22 of the server 20 stores the model data Dl in the server memory 23. Thereafter, the data acquisition part 22A of the server 20 acquires the model data D1 from the server memory 23 at a predetermined timing (for example, a timing when the order is received from the user) (S101).

Next, the data generation part 22B of the server 20 generates the component data D3 so as to include the specifying object SO (S102). Furthermore, the data generation part 22B generates the image data of the article (S103). Then, the data generation part 22B stores the manufacturing data D2 including the image data and the component data D3 in the server memory 23 in association with the article ID. Incidentally, the data generation part 22B may generate the image data before generating the component data D3, or may generate the image data simultaneously with the component data D3.

Then, the transmission part 22C of the server 20 causes the server communicating part 24 to transmit the component data D3 included in the manufacturing data D2 to the supplier terminal 30 (S104). As a result, the manufacturing support process ends. Then, the acquisition part 37A of the supplier terminal 30 acquires the manufacturing data D2 transmitted from the server 20. In addition, the drawing generation part 37B of the supplier terminal 30 generates the drawing data of the component based on the component data D3. Furthermore, the terminal control part 37 of the supplier terminal 30 may generate an operation pattern of a machining device for machining the article or the component. Incidentally, the machining device may automatically form the mark WP on the component. Thereafter, the supplier manufactures each of the components constituting the article and welds the components to manufacture the article.

According to the manufacturing support system 100 described above, the component data D3 including the specifying object SO specifying the welding area WA is automatically generated. As a result, it is possible to eliminate the time and effort for the supplier to decide the welding area WA and to promptly start manufacturing the article. In addition, the specifying object SO enables the supplier to visually recognize the welding area WA and to suppress the error in welding.

Hitherto, the present invention has been described with reference to the embodiments, but the present invention is not limited to the above embodiments. Inventions modified within a range without contradictory to the present invention and inventions equivalent to the present invention are also included in the present invention. In addition, the embodiments and modifications and technical means included in the embodiments or the modifications can be appropriately combined within a range not contradictory to the present invention.

For example, at least a part of the data acquisition part 22A, the data generation part 22B, and the ID creation part 22D may be provided in the supplier terminal 30. In this case, the supplier terminal 30 acquires the model data D1 and generates the component data D3. In addition, the drawing generation part 37B may be provided in the server 20. In this case, drawing data is generated in the server 20, and the transmission part 22C causes to transmit the drawing data to the supplier terminal 30.

Some or all of the above embodiments can also be described as the following in Supplements, but are not limited to the following.

### Supplement 1

A manufacturing support system that transmits, to a supplier, component data for manufacturing an article including a plurality of components to be joined by welding, the component data representing a geometric shape of each of the components, the manufacturing support system comprising:
a data generation unit that generates the component data so as to include, as a part of the geometric shape, a specifying object specifying a welding area in the article; and
a transmission unit that transmits the generated component data to the supplier.

### Supplement 2

The manufacturing support system according to Supplement 1, wherein
the data generation unit generates the component data based on model data of the article, and
the specifying object is not included in the model data, and the specifying object, as a part of the geometric shape represented by the component data, has a set dimension.

### Supplement 3

The manufacturing support system according to Supplement 1 or 2, wherein
the component data includes a plurality of the specifying objects as a part of the geometric shape so as to indicate a start point and an end point of the welding area, and
shapes and/or at least some dimensions of the plurality of specifying objects are identical.

### Supplement 4

A manufacturing support program for a manufacturing support system that includes a computer and transmits, to a supplier, component data for manufacturing an article including a plurality of components to be joined by welding, the component data representing a geometric shape of each of the components, the manufacturing support program causing the computer to function as:
a data generation unit that generates the component data so as to include, as a part of the geometric shape, a specifying object specifying a welding area in the article; and
a transmission unit that transmits the generated component data to the supplier.

### Supplement 5

A control method for a manufacturing support system that includes a computer and transmits, to a supplier, component data for manufacturing an article including a plurality of components to be joined by welding, the component data representing a geometric shape of each of the components, the control method causing the computer to:
generate the component data so as to include, as a part of the geometric shape, a specifying object specifying a welding area in the article; and
transmit the generated component data to the supplier.

### Supplement 6

A terminal device comprising:
an acquisition unit that acquires component data for manufacturing an article including a plurality of components to be joined by welding, the component data representing a geometric shape of each of the components; and
a drawing generation unit that generates drawing data of the components based on the acquired component data,
wherein the component data includes, as part of the geometric shape, a specifying object specifying a welding area in the article.

What is claimed is:

1. A manufacturing support system that transmits, to a supplier, component data for manufacturing an article including a plurality of components to be joined by welding, the component data representing a geometric shape of each of the components, the manufacturing support system comprising:
a data generation unit that generates the component data based on model data of the article so as to include, as a part of the geometric shape, a specifying object specifying a welding area in the article; and
a transmission unit that transmits the generated component data to the supplier, wherein
the specifying object is not included in the model data, and the specifying object, as a part of the geometric shape represented by the component data, has a set dimension.

2. (canceled)

3. The manufacturing support system according to claim 1, wherein
the component data includes a plurality of the specifying objects as a part of the geometric shape so as to indicate a start point and an end point of the welding area, and
shapes and/or at least some dimensions of the plurality of specifying objects are identical.

4. A manufacturing support program for a manufacturing support system that includes a computer and transmits, to a supplier, component data for manufacturing an article including a plurality of components to be joined by welding, the component data representing a geometric shape of each of the components, the manufacturing support program causing the computer to function as:
a data generation unit that generates the component data based on model data of the article so as to include, as a part of the geometric shape, a specifying object specifying a welding area in the article; and
a transmission unit that transmits the generated component data to the supplier, wherein
the specifying object is not included in the model data, and the specifying object, as a part of the geometric shape represented by the component data, has a set dimension.

5. A control method for a manufacturing support system that includes a computer and transmits, to a supplier, component data for manufacturing an article including a plurality of components to be joined by welding, the component data representing a geometric shape of each of the components, the control method causing the computer to:
generate the component data based on model data of the article so as to include, as a part of the geometric shape, a specifying object specifying a welding area in the article; and
transmit the generated component data to the supplier, wherein
the specifying object is not included in the model data, and the specifying object, as a part of the geometric shape represented by the component data, has a set dimension.

6. A terminal device comprising:
an acquisition unit that acquires component data for manufacturing an article including a plurality of components to be joined by welding, the component data generated based on model data of the article and representing a geometric shape of each of the components; and
a drawing generation unit that generates drawing data of the components based on the acquired component data, wherein
the component data includes, as part of the geometric shape, a specifying object specifying a welding area in the article, and
the specifying object is not included in the model data, and the specifying object, as a part of the geometric shape represented by the component data, has a set dimension.
